(19) United States
(12) Patent Application Publication
(10) Pub. No.: US 2018/0065617 A1
(43) Pub. Date: Mar. 8, 2018

(54) Control Device of Hybrid Vehicle

(71) Applicant: TOYOTA JIDOSHA KABUSHIKI KAISHA, Toyota-shi (JP)

(72) Inventors: Michitaka TSUCHIDA, Miyoshi-shi (JP); Michinobu SUZUKI, Toyota-shi (JP); Yosuke SUZUKI, Hadano-shi (JP); Shinichi BABA, Toyota-shi (JP); Koichi KATO, Toyota-shi (JP); Shinichiro SUENAGA, Nagoya-shi (JP)

(73) Assignee: TOYOTA JIDOSHA KABUSHIKI KAISHA, Toyota-shi (JP)

(21) Appl. No.: 15/696,958

(22) Filed: Sep. 6, 2017

(30) Foreign Application Priority Data
Sep. 8, 2016 (JP) 2016-176002

(51) Int. Cl. B60W 10/08

(52) U.S. Cl. CPC B60W 10/08; B60K 6/365

(57) ABSTRACT

A control device for a hybrid vehicle includes a rotation detector and electronic control unit. The rotation detector is configured to detect a rotational state of the third rotational element of the hybrid vehicle. The electronic control unit is configured to control a first motor generator of the hybrid vehicle such that output torque of the first motor generator becomes zero when the electronic control unit determines, based on the rotational state of the third rotational element, that the third rotational element has a rotational fluctuation while the hybrid vehicle is travelling in a dual drive motor travelling mode. The dual drive motor travelling mode is a mode in which the hybrid vehicle travels while both the first motor generator and a second motor generator serve as driving force sources for travelling in a state where a first rotational element is fixed by a lock mechanism.

### INCORPORATION BY REFERENCE

The disclosure of Japanese Patent Application No. 2016-176002 filed on Sep. 8, 2016 including the specification, drawings and abstract is incorporated herein by reference in its entirety.

### BACKGROUND

### 1. Technical Field

The present disclosure relates to a control device of a hybrid vehicle that is able to travel while both a first motor generator and a second motor generator serve as driving force sources for travelling in a state where a predetermined rotational element is fixed so as not to be rotatable in a differential mechanism.

### 2. Description of Related Art

There is a well-known control device of a hybrid vehicle including an engine, a first motor generator, a differential mechanism, a second motor generator, and a lock mechanism. The differential mechanism includes a first rotational element, a second rotational element, and a third rotational element. The engine is interlocked with the first rotational element in a power transmittable manner. The first motor generator is interlocked with the second rotational element in a power transmittable manner. The third rotational element is interlocked with driving wheels of the hybrid vehicle. The second motor generator is interlocked with the driving wheels in a power transmittable manner. The lock mechanism is configured to fix the first rotational element such that the first rotational element is not rotatable. Japanese Unexamined Patent Application Publication No. 2013-147124 (JP 2013-147124 A) discloses an example of the control device of the hybrid vehicle. In such a hybrid vehicle, when transmission torque resulting in a rotational fluctuation of the first rotational element is input from the driving wheel side, a load caused due to the rotational fluctuation of the first rotational element is applied to the lock mechanism that fixes the first rotational element such that the first rotational element is not rotatable, so that there is a possibility that durability of the lock mechanism deteriorates. In regard to this matter, JP 2013-147124 A discloses that when a rotational fluctuation of the first rotational element is detected, the first motor generator increases the rotational speed of the first rotational element to a predetermined rotational speed higher than zero, so that any load caused due to a rotational fluctuation of the first rotational element is not applied to the lock mechanism and deterioration of durability of the lock mechanism is restrained.

### SUMMARY

Incidentally, in the differential mechanism having the first rotational element, the second rotational element, and the third rotational element as described above, when the rotational speed of the first rotational element is increased by the first motor generator, reaction force corresponding to an increased amount of the rotational speed caused by output torque of the first motor generator is input to the third rotational element. Therefore, when the deterioration of durability of the lock mechanism is restrained, there is a possibility of an occurrence of a shock or unintended deterioration of driving force.

The present disclosure provides a control device of a hybrid vehicle in which deterioration of durability of a lock mechanism can be restrained against a rotational fluctuation of a third rotational element and a shock or unintended deterioration of driving force can be restrained.

An aspect of the present disclosure relates to a control device for a hybrid vehicle in which the hybrid vehicle includes an engine, a first motor generator, a differential mechanism, a second motor generator, and a lock mechanism. The differential mechanism includes a first rotational element, a second rotational element, and a third rotational element. The engine is interlocked with the first rotational element in a power transmittable manner. The first motor generator is interlocked with the second rotational element in a power transmittable manner. The third rotational element is interlocked with driving wheels of the hybrid vehicle. The second motor generator is interlocked with the driving wheels in a power transmittable manner. The lock mechanism is configured to fix the first rotational element such that the first rotational element is selectively not rotatable. The control device includes a rotation detector and an electronic control unit. The rotation detector is configured to detect a rotational state of the third rotational element. The electronic control unit is configured to control the lock mechanism, the first motor generator, and the second motor generator such that the hybrid vehicle travels in a dual drive motor travelling mode, the dual drive motor travelling mode being a mode in which the hybrid vehicle travels while both the first motor generator and the second motor generator serve as driving force sources for travelling in a state where the first rotational element is fixed by the lock mechanism. The electronic control unit is configured to control the first motor generator such that output torque of the first motor generator becomes zero when the electronic control unit determines, based on the rotational state of the third rotational element, that the third rotational element has a rotational fluctuation while the hybrid vehicle is travelling in the dual drive motor travelling mode.

In the control device of the hybrid vehicle according to the aspect, the electronic control unit may be configured to cause the hybrid vehicle to switch from the dual drive motor travelling mode to a single drive motor travelling mode in which solely the second motor generator serves as the driving force source for travelling such that the output torque of the first motor generator becomes zero.

In the control device of the hybrid vehicle according to the aspect, the lock mechanism may be a one-way clutch allowing the first rotational element to rotate in a positive rotational direction that is a rotation direction at a time when the engine runs and inhibiting the first rotational element from rotating in a negative rotational direction.

In the control device of the hybrid vehicle according to the aspect, the electronic control unit may be configured to determine that the third rotational element has a rotational fluctuation when the third rotational element is in a rotational state corresponding to a wavy road travelling state of the hybrid vehicle.

In the control device of the hybrid vehicle according to the aspect, the electronic control unit may be configured to calculate an integral value per predetermined time of an absolute value of a band-pass processing value for a rotational speed of the third rotational element, as a band-pass total sum. The electronic control unit may be configured to determine that the third rotational element has a rotational fluctuation when the band-pass total sum is equal to or greater than a wavy road determination threshold value.

According to the aspect, when a rotational fluctuation is caused in the third rotational element due to transmission torque input from the driving wheels while the hybrid vehicle is travelling in the dual drive motor travelling mode, torque resulting in a rotational fluctuation of the first rotational element is input to the first rotational element, and the first motor generator outputs torque for travelling, so that the torque resulting in a rotational fluctuation of the first rotational element increases. Therefore, there is an occurrence of a shock input to the lock mechanism accompanying a significant load applied to the lock mechanism. In regard to this matter, when the electronic control unit determines, based on the rotational state of the third rotational element, that the third rotational element has a rotational fluctuation while the hybrid vehicle is travelling in the dual drive motor travelling mode, the output torque of the first motor generator becomes zero, so that an increased amount of torque caused by the output torque of the first motor generator resulting in a rotational fluctuation of the first rotational element is cancelled and a shock input to the lock mechanism is reduced. Thus, it is possible to restrain the deterioration of durability of the lock mechanism against a rotational fluctuation of the third rotational element. In addition, in restraining the deterioration of durability of the lock mechanism, since any reaction force caused by the output torque of the first motor generator is not input to the third rotational element, it is possible to restrain a shock or unintended deterioration of driving force.

In addition, according to the aspect, when the hybrid vehicle switches from the dual drive motor travelling mode to the single drive motor travelling mode, the output torque of the first motor generator becomes zero. Therefore, even if the engine is not caused to start, it is possible to restrain the deterioration of durability of the lock mechanism against a rotational fluctuation of the third rotational element, and it is possible to restrain a shock or unintended deterioration of driving force.

In addition, according to the aspect, the lock mechanism is the one-way clutch. Therefore, the hybrid vehicle can appropriately travel in the dual drive motor travelling mode in a state where the first rotational element is fixed. In addition, when a rotational fluctuation of the third rotational element is detected while the hybrid vehicle is travelling in the dual drive motor travelling mode, the output torque of the first motor generator becomes zero. Therefore, it is possible to restrain the deterioration of durability of the one-way clutch, and it is possible to restrain a shock or unintended deterioration of driving force.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is a view illustrating a schematic configuration of each of the elements related to travelling of a vehicle in which the present disclosure is applied, and a main portion of a control system for controlling each of the elements;

FIG. 2 is a partial sectional view illustrating an interlocked part between a crankshaft and an input shaft;

FIG. 3 is a nomographic chart that can show rotational speeds of rotational elements relative to each other in a planetary gear mechanism, and in which the solid line illustrates an example of a travelling state of the vehicle when the vehicle is travelling in an EV travelling mode and the dotted line illustrates an example of the travelling state of the vehicle when the vehicle is travelling in an HV travelling mode;

FIG. 4 is a view using a nomographic chart similar to that in FIG. 3 and illustrating a phenomenon of when transmission torque resulting in a rotational fluctuation of ring gears while the vehicle is travelling in an EV2 mode is input from driving wheels;

FIG. 5 is a view using a nomographic chart similar to that in FIG. 3 and illustrating a phenomenon of when transmission torque resulting in a rotational fluctuation of the ring gears while the vehicle is travelling in an EV1 mode is input from the driving wheels;

FIG. 6 is a flowchart illustrating a main portion in a control operation of an electronic control unit, that is, a control operation in which deterioration of durability of a lock mechanism can be restrained against a rotational fluctuation of a third rotational element of the planetary gear mechanism and a shock or unintended deterioration of driving force is restrained;

FIG. 7 is a time chart of when the control operation illustrated in the flowchart of FIG. 6 is executed;

FIG. 8 is a view illustrating a meshing clutch that is an example of the lock mechanism different from a one-way clutch; and

FIG. 9 is a view illustrating a brake that is another example of the lock mechanism different from the one-way clutch.

### DETAILED DESCRIPTION OF EMBODIMENTS

Hereinafter, embodiments of the present disclosure will be described in detail with reference to the drawings.

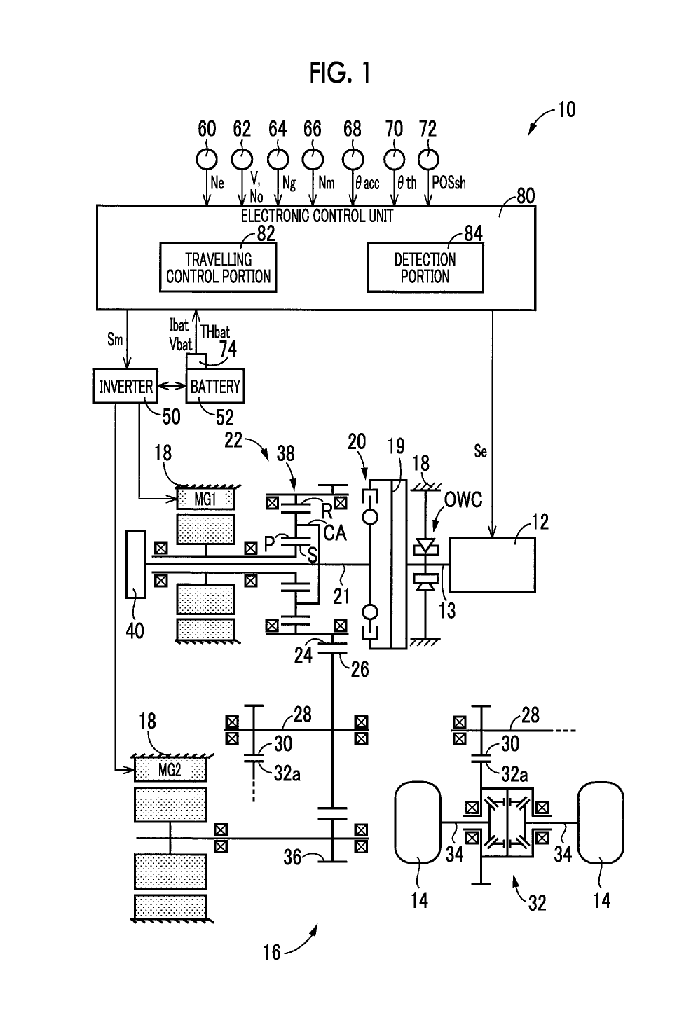

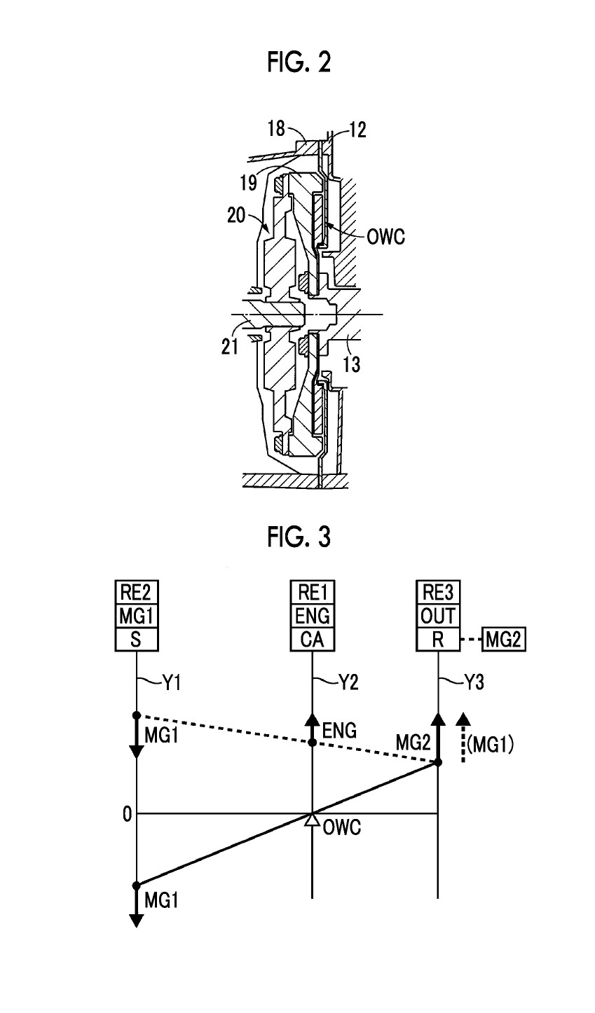

FIG. 1 is a view illustrating a schematic configuration of each of the elements related to travelling of a vehicle 10 in which the present disclosure is applied, and a main portion of a control system for controlling each of the elements. In addition, FIG. 2 is a partial sectional view illustrating an interlocked part between a crankshaft 13 and an input shaft 21 (will be described later).

In FIG. 1, the vehicle 10 is a hybrid vehicle including an engine 12, a first motor generator MG1, and a second motor generator MG2 serving as a plurality of driving force sources each of which generates driving torque and can be a driving force source for travelling. In addition, the vehicle 10 includes driving wheels 14 and a power transmission device 16 that is provided in a power transmission route between the engine 12 and the driving wheels 14.

The engine 12 is a known internal combustion engine, for example, a gasoline engine or a diesel engine that causes predetermined fuel to combust and outputs power. In the engine 12, an electronic control unit 80 (will be described later) controls the running state including the throttle opening degree, the intake air quantity, the fuel supply quantity, the ignition time, and the like, thereby controlling engine torque Te.

Both the first motor generator MG1 and the second motor generator MG2 are motor generators each of which can be the driving force source for travelling, that is, so-called motor generators each of which has a function as a motor generating driving torque and a function as a generator. Each of the first motor generator MG1 and the second motor generator MG2 is connected to a battery 52 (will be described later) via an inverter 50 (will be described later). The electronic control unit 80 (will be described later) controls the inverter 50, thereby controlling MG1 torque Tg and MG2 torque Tm each of which is output torque (powering torque or regenerative torque) of the corresponding one of the first motor generator MG1 and the second motor generator MG2.

In FIGS. 1 and 2, the power transmission device 16 includes a fly wheel 19, a damper 20, a transmission portion 22, a driven gear 26, a driven shaft 28, a final gear 30, a differential gear 32, and the like inside a case 18 that is a non-rotational member attached to a vehicle body. The fly wheel 19 is interlocked with the crankshaft 13 that is a rotating shaft of the engine 12. The damper 20 causes the fly wheel 19 and the transmission portion 22 (that is, the input shaft 21 that is an input rotational member of the transmission portion 22) to be interlocked with each other. The driven gear 26 meshes with a drive gear 24 that is an output rotational member of the transmission portion 22. The driven shaft 28 fixes the driven gear 26 such that the driven gear 26 is not rotatable relative to the driven shaft 28. The final gear 30 is fixed to the driven shaft 28 so as not to be rotatable relative to the driven shaft 28 (the final gear 30 having a diameter smaller than that of the driven gear 26). The differential gear 32 meshes with the final gear 30 via a differential ring gear 32a. In addition, the power transmission device 16 includes an axle 34 interlocked with the differential gear 32, and the like. In addition, the power transmission device 16 includes a reduction gear 36 (the reduction gear 36 having a diameter smaller than that of the driven gear 26) and the like inside the case 18. The reduction gear 36 meshes with the driven gear 26 and is interlocked with the second motor generator MG2. Accordingly, the second motor generator MG2 is interlocked with the driving wheels 14 in a power transmittable manner. In the power transmission device 16 having the above-described configuration, power of the engine 12, power of the first motor generator MG1, or power of the second motor generator MG2 is transmitted to the driven gear 26 and the transmitted power is transmitted from the driven gear 26 to the driving wheels 14 via the final gear 30, the differential gear 32, the axle 34, and the like in sequence.

The transmission portion 22 has a planetary gear mechanism 38 serving as a power split device that splits (or distributes) power, which has been transmitted from the engine 12 to the input shaft 21 via the damper 20 and the like, into the first motor generator MG1 and the drive gear 24. The planetary gear mechanism 38 is a known single pinion-type planetary gear device including sun gears S, pinion gears P, a carrier CA, and ring gears R. The carrier CA supports the pinion gears P such that the pinion gears P are rotatable on their axes and are able to revolve. The ring gears R each mesh with the corresponding one of the sun gears S via the pinion gears P respectively. The planetary gear mechanism 38 functions as a differential mechanism generating a differential action. The carrier CA is integrally interlocked with the input shaft 21. The carrier CA is a rotational element (for example, a first rotational element RE1) serving as an input element with which the engine 12 is interlocked via the input shaft 21 in a power transmittable manner. The sun gears S are integrally interlocked with a rotor shaft of the first motor generator MG1. The sun gears S form a rotational element (for example, a second rotational element RE2) serving as a reaction force element with which the first motor generator MG1 is interlocked in a power transmittable manner. The ring gears R form a rotational element (for example, a third rotational element RE3) serving as an output element that is integrally interlocked with the drive gear 24 and is interlocked with the driving wheels 14. Thus, in the vehicle 10, reaction force of the engine torque Te input to the carrier CA is taken by the first motor generator MG1, so that engine travelling can be performed due to direct transmission torque (also referred to as direct engine transmission torque) that is mechanically transmitted to the ring gears R, and the MG2 torque Tm of the second motor generator MG2 driven by electric power of the first motor generator MG1 generated by power split from the engine 12 for the first motor generator MG1. Accordingly, the transmission portion 22 functions as a known electric differential portion (electric continuously variable transmission) in which the electronic control unit 80 (will be described later) controls the inverter 50 such that the running state of the first motor generator MG1 is controlled, and the gear ratio is controlled. That is, the transmission portion 22 is an electric transmission mechanism having the planetary gear mechanism 38 with which the engine 12 is interlocked in a power transmittable manner, and the first motor generator MG1 with which the planetary gear mechanism 38 is interlocked in a power transmittable manner. When the running state of the first motor generator MG1 is controlled, the differential state of the planetary gear mechanism 38 is controlled.

Moreover, the vehicle 10 includes a mechanical oil pump 40, a one-way clutch OWC, the inverter 50, the battery 52, and the like. The mechanical oil pump 40 is interlocked with the input shaft 21 and is rotationally driven by the engine 12 so as to supply hydraulic fluid (oil) used for lubricating each of the elements of the power transmission device 16, such as the planetary gear mechanism 38. The one-way clutch OWC serves as a lock mechanism fixing the carrier CA (here, also including the input shaft 21 that integrally rotates with the carrier CA) such that the carrier CA is not rotatable (that is, the crankshaft 13 of the engine 12 is fixed to the case 18). The inverter 50 controls supplying and receiving electric power related to an operation of each of the motor generators MG1, MG2 so as to obtain the demanded MG1 torque Tg from the first motor generator MG1 and the demanded MG2 torque Tm from the second motor generator MG2. The battery 52 serves as an electrical storage device supplying and receiving electric power with respect to each of the first motor generator MG1 and the second motor generator MG2.

In the one-way clutch OWC, one member of two members that are rotatable relative to each other is integrally interlocked with the crankshaft 13, and the other member is integrally interlocked with the case 18. The one-way clutch OWC is released in a rotation direction of when the engine 12 runs (positive rotational direction), and the one-way clutch OWC is automatically engaged in a rotation direction opposite to that of when the engine 12 runs. Therefore, when the one-way clutch OWC is released, the engine 12 (crankshaft 13) is in a state of being rotatable relative to the case 18. Meanwhile, when the one-way clutch OWC is engaged, the engine 12 (crankshaft 13) is in a state of being not rotatable relative to the case 18. That is, due to the engagement of the one-way clutch OWC, the engine 12 (crankshaft 13) is fixed (locked) to the case 18. In this manner, the one-way clutch OWC allows the carrier CA to rotate in the positive rotational direction that is a rotation direction of when the engine 12 runs and inhibits the carrier CA from rotating in a negative rotational direction (that is, the engine 12 (crankshaft 13) is allowed to rotate in the positive rotational direction and is inhibited from rotating in the negative rotational direction).

Moreover, the vehicle 10 includes the electronic control unit 80 including a control device that controls each of the elements related to travelling. The electronic control unit 80 is configured to include a so-called microcomputer that includes, for example, a CPU, a RAM, a ROM, and an input-output interface. The CPU utilizes the temporary storage function of the RAM and performs signal processing in accordance with a program stored in the ROM in advance, thereby executing various control operations of the vehicle 10. For example, the electronic control unit 80 executes vehicle control operations such as hybrid drive control operations related to the engine 12, the first motor generator MG1, and the second motor generator MG2. As necessary, the electronic control unit 80 is configured to include a computer for controlling an engine, a computer for controlling a motor generator, and the like.

Various signals (for example, an engine rotational speed Ne, an output rotational speed No that is a rotational speed of the drive gear 24 corresponding to a vehicle speed V, an MG1 rotational speed Ng that is a rotational speed of the first motor generator MG1, an MG2 rotational speed Nm that is a rotational speed of the second motor generator MG2, an accelerator operation amount θacc that is an operation amount of an accelerator pedal and shows the magnitude of an accelerating operation (accelerator operation) of a driver, a throttle valve opening degree θth that is an opening degree of an electronic throttle valve, an operation position (shift position) POSsh such as “P”, “R”, “N”, and “D” of a shift lever, a battery temperature THbat of the battery 52, a battery charging/discharging current Ibat, and a battery voltage Vbat) based on detection values of various sensors (for example, an engine rotational speed sensor 60, an output rotational speed sensor 62, an MG1 rotational speed sensor 64 such as a resolver, an MG2 rotational speed sensor 66 such as a resolver, an accelerator operation amount sensor 68, a throttle valve opening degree sensor 70, a shift position sensor 72, and a battery sensor 74) included in the vehicle 10 are supplied to the electronic control unit 80. In addition, the electronic control unit 80 outputs various command signals (for example, an engine control command signal Se for controlling the engine 12, and a motor generator control command signal Sm for operating the inverter 50 controlling each of the motor generators MG1, MG2) to the corresponding one of the devices (for example, the engine 12, and the inverter 50) included in the vehicle 10. The electronic control unit 80 calculates a charge state (charging capacity) SOC of the battery 52 based on, for example, the battery charging/discharging current Ibat and the battery voltage Vbat.

The electronic control unit 80 includes travelling control means, that is, a travelling control portion 82 for realizing a control function for performing various control operations in the vehicle 10.

The travelling control portion 82 controls opening and closing of the electronic throttle valve, controls the fuel injection quantity and the injection time, outputs the engine control command signal Se for controlling the ignition time, and executes an output control operation of the engine 12 so as to obtain the target value of the engine torque Te. In addition, the travelling control portion 82 outputs the motor generator control command signal Sm for controlling an operation of the first motor generator MG1 or the second motor generator MG2 to the inverter 50 and executes an output control operation of the first motor generator MG1 or the second motor generator MG2 so as to obtain the target value of the MG1 torque Tg or the MG2 torque Tm.

Specifically, the travelling control portion 82 calculates the demanded driving torque for the vehicle speed V at that moment (demanded driving torque), based on the accelerator operation amount θacc. The travelling control portion 82 causes at least one of the engine 12, the first motor generator MG1, and the second motor generator MG2 to generate the demanded driving torque so as to realize running of low fuel consumption with a small quantity of exhaust gas based on a demanded charge value (demanded charge power) and the like. That is, the travelling control portion 82 causes the hybrid vehicle to switch among a plurality of travelling modes respectively using the driving force sources different from each other as the driving force source for travelling in accordance with the travelling state.

The travelling control portion 82 selectively adopts a motor travelling (also referred to as EV travelling) mode or a hybrid travelling (also referred to as HV travelling) mode as the travelling mode in accordance with the travelling state. For example, the travelling control portion 82 adopts the EV travelling mode when the demanded driving torque is in a motor travelling region smaller than a threshold value that is obtained and stored in advance (that is, set in advance) through an experimentation or the design. The travelling control portion 82 adopts the HV travelling mode when the demanded driving torque is in a hybrid travelling region equal to or greater than the threshold value set in advance. In addition, the travelling control portion 82 adopts the HV travelling mode when the charging capacity SOC is less than the threshold value set in advance even if the demanded driving torque is in the motor travelling region.

When the EV travelling mode is adopted, the travelling control portion 82 stops the engine 12 from running and enables the hybrid vehicle to perform the motor travelling (EV travelling) in which at least one motor generator (particularly, the second motor generator MG2) of the first motor generator MG1 and the second motor generator MG2 serves as the driving force source for travelling. When the EV travelling mode is adopted, in a case where solely the second motor generator MG2 can cover the demanded driving torque, the travelling control portion 82 adopts a single drive EV travelling mode (also referred to as EV1 mode), and in a case where solely the second motor generator MG2 cannot cover the demanded driving torque, the travelling control portion 82 adopts a dual drive EV travelling mode (also referred to as EV2 mode). When the EV1 mode is adopted, the travelling control portion 82 enables the hybrid vehicle to perform the EV travelling in which solely the second motor generator MG2 serves as the driving force source for travelling, and when the EV2 mode is adopted, the travelling control portion 82 enables the hybrid vehicle to perform the EV travelling in which both the first motor generator MG1 and the second motor generator MG2 serve as the driving force sources for travelling. As described above, the EV1 mode is the EV travelling mode in which solely the second motor generator MG2 serves as the driving force source for travelling (that is, solely the second motor generator MG2 is operated and single driving of the second motor generator MG2 is executed), and the EV2 mode is the EV travelling mode in which both the first motor generator MG1 and the second motor generator MG2 serve as the driving force sources for travelling (that is, both the first motor generator MG1 and the second motor generator MG2 are operated and dual driving of the two motor generators is executed). Even when solely the second motor generator MG2 can cover the demanded driving torque, in a case where an operation point (running point) of the second motor generator MG2 shown based on the MG2 rotational speed Nm and the MG2 torque Tm is in a range set in advance as an operation point that causes efficiency of the second motor generator MG2 to deteriorate (in other words, in a case where it is more efficient when both the first motor generator MG1 and the second motor generator MG2 are used), the travelling control portion 82 adopts the EV2 mode. When the EV2 mode is adopted, the travelling control portion 82 allots the demanded driving torque to the first motor generator MG1 and the second motor generator MG2 based on the running efficiency of the first motor generator MG1 and the second motor generator MG2.

In the EV2 mode, in a state where the engine 12 is stopped from running and the engine rotational speed Ne becomes zero, when the first motor generator MG1 is driven (powered) by negative rotation and negative torque, the one-way clutch OWC is automatically engaged such that the crankshaft 13 is inhibited from rotating in the negative rotational direction. In a state where the one-way clutch OWC is engaged, since reaction force torque caused by powering torque of the first motor generator MG1 is input to the drive gear 24 via the planetary gear mechanism 38 in a state where the carrier CA is fixed so as not to be rotatable, the powering torque of the first motor generator MG1 is transmitted to the driving wheels 14 as driving torque in the vehicle forward movement direction. Therefore, in the EV2 mode, in a state where the engine 12 is stopped from rotating, if both the first motor generator MG1 and the second motor generator MG2 are driven (powered), the hybrid vehicle can travel while the two motor generators MG1, MG2 serve as the driving force sources for travelling. In this manner, the travelling control portion 82 can cause the vehicle 10 to travel in the EV2 mode in a state where the carrier CA of the planetary gear mechanism 38 is fixed by the one-way clutch OWC. Accordingly, for example, in a so-called plug-in hybrid vehicle of which the battery 52 can be charged from an external power source such as a charging station and a household power source, when the battery 52 is increased in capacity (has a high-output), the second motor generator MG2 is restrained from increasing in size and the high-output EV travelling is easily realized.

When the HV travelling mode is adopted, the travelling control portion 82 causes reaction force against power of the engine 12 to be taken for generating the power of the first motor generator MG1 and causes the direct engine transmission torque to be transmitted to the drive gear 24. The travelling control portion 82 drives the second motor generator MG2 by using generated electric power of the first motor generator MG1 and causes torque to be transmitted to the driving wheels 14, thereby enabling the hybrid vehicle to perform the HV travelling (also referred to as engine travelling) in which at least the engine 12 serves as the driving force source for travelling. That is, when the HV travelling mode is adopted, the travelling control portion 82 controls the running state of the first motor generator MG1 and enables the hybrid vehicle to perform the HV travelling, that is travelling in which power of the engine 12 is transmitted to the driving wheels 14. In the HV travelling mode, the hybrid vehicle can travel by additionally applying driving torque of the second motor generator MG2 generated by using electric power from the battery 52.

When the hybrid vehicle switches from the EV travelling mode to the HV travelling mode, the travelling control portion 82 increases the engine rotational speed Ne by using the first motor generator MG1 and performs ignition, so that the engine 12 starts. In addition, when the hybrid vehicle switches from the HV travelling mode to the EV travelling mode, the travelling control portion 82 stops the fuel supply to the engine 12, thereby stopping the engine 12 from running. In this case, the travelling control portion 82 may promptly stop the engine 12 from rotating by lowering the engine rotational speed Ne by using the first motor generator MG1 compared to when the engine rotational speed Ne is lowered in the course of nature.

FIG. 3 is a nomographic chart that can show the rotational speeds of the three rotational elements RE1, RE2, RE3 relative to each other in the planetary gear mechanism 38. In the nomographic chart, in regard to the vertical lines Y1 to Y3 in sequence from the left side on the sheet, the vertical line Y1 indicates the rotational speed of the sun gears S that form the second rotational element RE2 interlocked with the first motor generator MG1, the vertical line Y2 indicates the rotational speed of the carrier CA that forms the first rotational element RE1 interlocked with the engine 12 (ENG), and the vertical line Y3 indicates the rotational speed of the ring gears R that form the third rotational element RE3 integrally rotating with the drive gear 24 (OUT), respectively. The second motor generator MG2 is interlocked with the third rotational element RE3 via the driven gear 26, the reduction gear 36, and the like. The solid lines in FIG. 3 indicate an example of relative speeds of the rotational elements in a travelling state at the time of the EV travelling mode, and the dotted lines in FIG. 3 indicate an example of relative speeds of the rotational elements in a travelling state at the time of the HV travelling mode.

An operation of the vehicle 10 in the EV1 mode of the EV travelling mode will be described by using the solid lines in FIG. 3. The engine 12 is not driven (that is, the engine 12 is in a running stop state). In addition, the first motor generator MG1 is in a no-load state (free) and the engine rotational speed Ne becomes zero. In the EV1 mode, the one-way clutch OWC is released, and the crankshaft 13 of the engine 12 is not fixed to the case 18. In this state, powering torque of the second motor generator MG2 is transmitted to the driving wheels 14 as driving force in the vehicle forward movement direction.

In addition, an operation of the vehicle 10 in the EV2 mode of the EV travelling mode will be described by using the solid lines in FIG. 3. The engine 12 is not driven and the engine rotational speed Ne becomes zero. In the EV2 mode, the one-way clutch OWC is engaged such that the crankshaft 13 of the engine 12 is fixed to the case 18. Therefore, the engine 12 is fixed (locked) so as not to be rotatable. In a state where the one-way clutch OWC is engaged, in addition to powering torque of the second motor generator MG2, powering torque of the first motor generator MG1 is also transmitted to the driving wheels 14 as driving force in the vehicle forward movement direction. In this manner, in the vehicle 10, the crankshaft 13 of the engine 12 is locked by the one-way clutch OWC, so that both the first motor generator MG1 and the second motor generator MG2 can be used as the driving force sources for travelling.

In addition, an operation of the vehicle 10 in the HV travelling mode will be described by using the dotted lines in FIG. 3. In this state, the one-way clutch OWC is released, and the crankshaft 13 of the engine 12 is not fixed to the case 18. With respect to the engine torque Te input to the carrier CA, the MG1 torque Tg is input to the sun gears S. In this case, for example, a control operation in which the operation point of the engine 12 shown based on the engine rotational speed Ne and the engine torque Te is set to an operation point having the best fuel consumption can be executed by controlling powering of the first motor generator MG1 or controlling its reaction force. The type of hybrid vehicles of this kind is called a mechanical split type or a split type.

Incidentally, there is a possibility that a torque fluctuation caused in the driving wheels 14 due to repetitive slipping and gripping of the driving wheels 14 when the vehicle 10 travels on a rough road is transmitted from the driving wheels 14 to the planetary gear mechanism 38. For example, when the vehicle 10 travels on a wavy road having a wavy road surface and the driving wheels 14 are in a travelling state in which slipping and gripping are repeated, there is a possibility that transmission torque resulting in a rotational fluctuation of the output rotational members (for example, the drive gear 24 and the ring gears R of the planetary gear mechanism 38) of the transmission portion 22 generated due to unsprung vehicle resonance on a wavy road is input from the driving wheels 14. Consequently, a rotational fluctuation is also caused in the crankshaft 13 of the engine 12. Therefore, when the engine 12 is stopped from rotating as in a case where the hybrid vehicle is travelling in the EV travelling mode, a load is applied to the one-way clutch OWC due to the rotational fluctuation, and there is a possibility that durability of the one-way clutch OWC deteriorates.

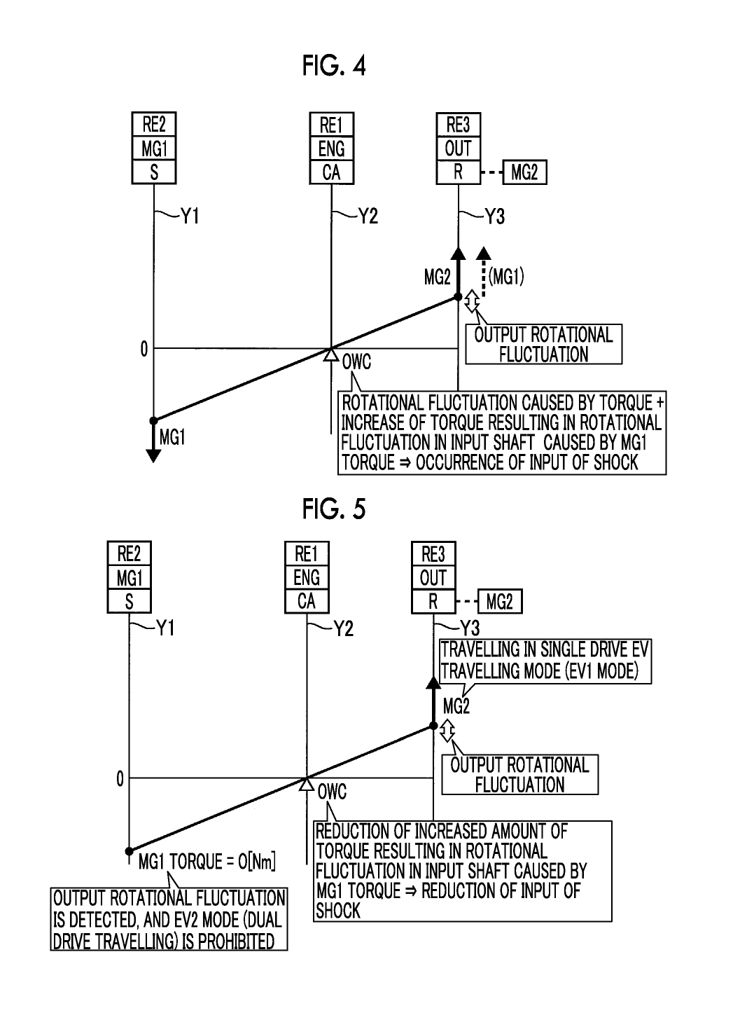

FIG. 4 is a view using a nomographic chart similar to that in FIG. 3 and illustrating a phenomenon of when transmission torque resulting in a rotational fluctuation of the drive gear 24 (here, also including the ring gears R) while the hybrid vehicle is travelling in the EV2 mode is input from the driving wheels 14. In FIG. 4, when a rotational fluctuation is caused in the ring gears R, which are the output rotational members of the transmission portion 22, due to transmission torque input from the driving wheels 14 while the hybrid vehicle is travelling in the EV2 mode, torque resulting in a rotational fluctuation of the carrier CA is input to the carrier CA of the planetary gear mechanism 38. That is, torque resulting in a rotational fluctuation of the input shaft 21 or the crankshaft 13 is input. Additionally, in the EV2 mode, since the first motor generator MG1 outputs torque for travelling (that is, torque to serve as driving torque), the MG1 torque Tg is also used to bear transmission torque input from the driving wheels 14. Therefore, torque resulting in a rotational fluctuation of the carrier CA increases. That is, torque resulting in a rotational fluctuation of the input shaft 21 or the crankshaft 13 increases. That is, a load is concentrated on a fulcrum on the crankshaft 13 in the straight line in the nomographic chart indicating that the hybrid vehicle is travelling in the EV2 mode. Therefore, there is an occurrence of a shock input to the one-way clutch OWC accompanying a significant load to the one-way clutch OWC.

FIG. 5 is a view using a nomographic chart similar to that in FIG. 3 and illustrating a phenomenon of when transmission torque resulting in a rotational fluctuation of the ring gears R while the hybrid vehicle is travelling in the EV1 mode is input from the driving wheels 14. In FIG. 5, since the first motor generator MG1 does not output torque for travelling while the hybrid vehicle is travelling in the EV1 mode, there is no occurrence of an increased amount of torque resulting in a rotational fluctuation of the carrier CA caused by the MG1 torque Tg. That is, there is no occurrence of an increased amount of torque resulting in a rotational fluctuation of the input shaft 21 or the crankshaft 13. Therefore, when a rotational fluctuation of the ring gears R is detected while the hybrid vehicle is travelling in the EV2 mode, the EV2 mode is prohibited and the MG1 torque Tg becomes zero, so that the increased amount of torque resulting in a rotational fluctuation of the input shaft 21 or the crankshaft 13 caused by to the MG1 torque Tg can be reduced from the torque resulting in a rotational fluctuation of the input shaft 21 or the crankshaft 13. Accordingly, a load applied to the one-way clutch OWC can decrease, so that a shock input to the one-way clutch OWC can be reduced. Thus, it is possible to restrain the deterioration of durability of the one-way clutch OWC.

The electronic control unit 80 further includes a detection portion 84 configured to detect a rotational fluctuation of the output rotational members of the transmission portion 22 in order to realize a control operation of restraining the deterioration of durability of the one-way clutch OWC.

The detection portion 84 detects a rotational fluctuation of the output rotational members (for example, the drive gear 24 and the ring gears R of the planetary gear mechanism 38) of the transmission portion 22. That is, the detection portion 84 determines whether or not the output rotational members of the transmission portion 22 rotationally fluctuate. Detecting a rotational fluctuation is determining, for example, whether or not there is an occurrence of unsprung vehicle resonance on a wavy road. In other words, the detection portion 84 determines whether or not the hybrid vehicle is travelling on a wavy road. An example of a method in which the detection portion 84 detects a rotational fluctuation of the output rotational members of the transmission portion 22 (in other words, determining that the hybrid vehicle is travelling on a wavy road) will be described below.

As a rotation detector detecting a rotational fluctuation of the output rotational members of the transmission portion 22, the output rotational speed sensor 62 detecting the output rotational speed No that is a rotational speed of the output rotational members of the transmission portion 22 may be used. Alternatively, more desirably, the MG2 rotational speed sensor 66 such as a resolver that can detect the MG2 rotational speed Nm with accuracy may be used. Hereinafter, a case where the MG2 rotational speed sensor 66 is used as the rotation detector detecting the MG2 rotational speed Nm will be described. A fluctuation component of the MG2 rotational speed Nm is extracted through band-pass filter processing, and a band-pass processing value of the MG2 rotational speed Nm is calculated. The filter frequency of the band-pass filter processing is a particular range of transmission torque (fluctuation component) generated due to unsprung vehicle resonance on the wavy road. Since the band-pass processing value of the MG2 rotational speed Nm is a value that straddles the zero value and fluctuates, an integral value per predetermined time of the absolute value of the band-pass processing value is calculated as the band-pass total sum. When the band-pass total sum is equal to or greater than a wavy road determination threshold value, the detection portion 84 determines that the output rotational members of the transmission portion 22 rotationally fluctuate (that is, determines that the hybrid vehicle is travelling on a wavy road). When the band-pass total sum falls below a wavy road end threshold value (<wavy road determination threshold value) while the detection portion 84 determines whether the hybrid vehicle is travelling on a wavy road, the detection portion 84 determines that the output rotational members of the transmission portion 22 do not rotationally fluctuate (that is, cancel the determination that the hybrid vehicle is travelling on a wavy road). There is a possibility that the band-pass total sum becomes equal to or greater than the wavy road determination threshold value even in a case of a single (one) slip of the driving wheels 14. Therefore, more desirably, focusing on the circumstances that the band-pass processing value straddles the zero value and fluctuates due to repetitive slipping and gripping of the driving wheels 14, determining whether or not the number of times of the band-pass processing value straddling the zero value exceeds a predetermined number of times may be added to the conditions for determining whether or not the hybrid vehicle is travelling on a wavy road, so that erroneous determination is prevented.

When the detection portion 84 of the electronic control unit 80 detects a rotational fluctuation of the output rotational members of the transmission portion 22 (for example, the drive gear 24 and the ring gears R of the planetary gear mechanism 38) while the hybrid vehicle is travelling in the EV2 mode, the travelling control portion 82 of the electronic control unit 80 outputs the motor generator control command signal Sm causing the MG1 torque Tg to be zero to the inverter 50. Specifically, the travelling control portion 82 causes the hybrid vehicle to switch from the EV2 mode to the EV1 mode, so that the MG1 torque Tg becomes zero.

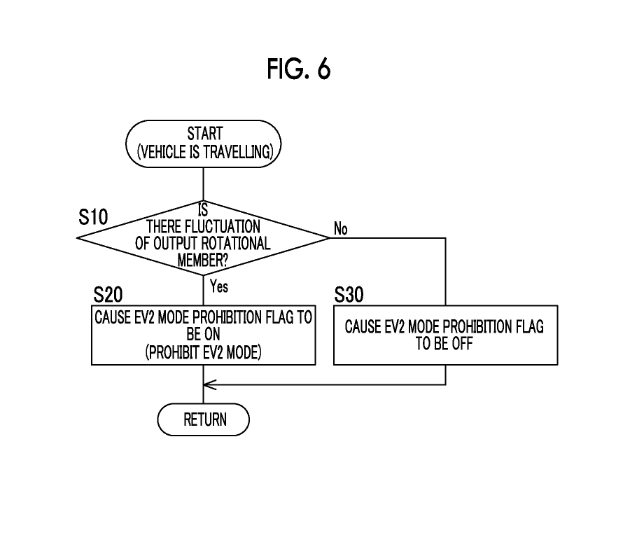

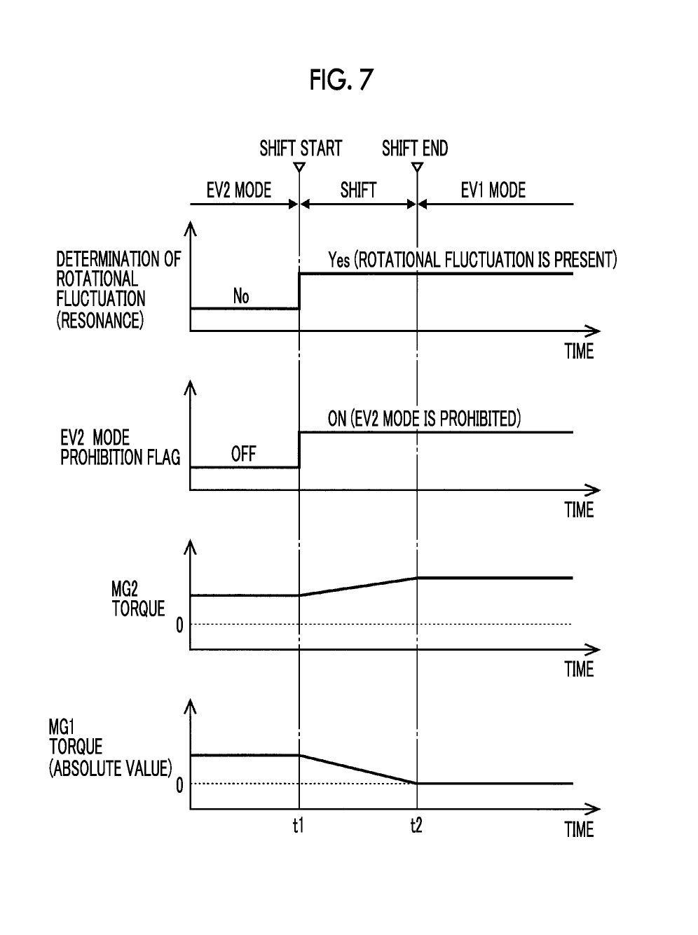

FIG. 6 is a flowchart illustrating a main portion in a control operation of the electronic control unit 80, that is, a control operation in which deterioration of durability of the lock mechanism can be restrained against a rotational fluctuation of the third rotational element RE3 of the planetary gear mechanism 38 and a shock or unintended deterioration of the driving force is restrained. For example, the control operation is repetitively executed while the hybrid vehicle is travelling. The travelling control portion 82 and the detection portion 84 are realized in the electronic control unit 80 by executing the process in the flowchart. FIG. 7 is a time chart of when the control operation illustrated in the flowchart of FIG. 6 is executed.

In FIG. 6, first, in Step (hereinafter, “Step” will not be affixed) S10 corresponding to the function of the detection portion 84, a rotational fluctuation of the output rotational members of the transmission portion 22 (for example, the drive gear 24 and the ring gears R of the planetary gear mechanism 38) is detected. That is, the detection portion 84 determines whether or not the output rotational members of the transmission portion 22 rotationally fluctuate. When the detection portion 84 makes a positive determination in S10, an EV2 mode prohibition flag is caused to be ON and the EV2 mode is prohibited in S20 corresponding to the function of the travelling control portion 82. If the hybrid vehicle is travelling in the EV2 mode, the EV2 mode is prohibited and the hybrid vehicle switches to the EV1 mode. That is, if the hybrid vehicle is travelling in the EV2 mode, the MG1 torque Tg becomes zero. Alternatively, if the vehicle is travelling in the EV1 mode, the hybrid vehicle is prohibited from shifting to the EV2 mode. Meanwhile, when the detection portion 84 makes a negative determination in S10, the EV2 mode prohibition flag is caused to be OFF in S30 corresponding to the function of the travelling control portion 82, and the routine ends.

In FIG. 7, time point t1 indicates that a rotational fluctuation of the output rotational members of the transmission portion 22 has been detected while the hybrid vehicle is travelling in the EV2 mode (that is, the detection portion 84 has determined that there is an occurrence of unsprung vehicle resonance on a wavy road). At time point t1, the EV2 mode prohibition flag is caused to be ON and the EV2 mode is prohibited. Accordingly, at time point t1, hybrid vehicle starts to shift from the EV2 mode to the EV1 mode. While a rotational fluctuation of the output rotational members of the transmission portion 22 is being detected, the EV2 mode prohibition flag remains ON (refer to time point t1 and thereafter), and the MG1 torque Tg gradually decreases toward zero from time point t1 (refer to the section between time point t1 and time point t2). In order to compensate for the decreased amount of driving torque accompanying the gradual decrease of the MG1 torque Tg, the MG2 torque Tm gradually increases from time point t1 (refer to the section between time point t1 and time point t2). The state at time point t2 shows that the MG1 torque Tg becomes zero and shifting to the EV1 mode ends. While the EV2 mode prohibition flag remains ON, the EV1 mode is maintained (refer to time point t2 and thereafter).

As described above, according to example, when a rotational fluctuation of the output rotational members of the transmission portion 22 (for example, the drive gear 24 and the ring gears R of the planetary gear mechanism 38) is detected while the hybrid vehicle is travelling in the EV2 mode, the MG1 torque Tg becomes zero. Therefore, the increased amount of torque resulting in a rotational fluctuation of the carrier CA of the planetary gear mechanism 38 caused by the MG1 torque Tg is cancelled, and a shock input to the one-way clutch OWC is reduced. Thus, it is possible to restrain the deterioration of durability of the lock mechanism (one-way clutch OWC) against a rotational fluctuation of the third rotational element RE3 (ring gears R). That is, it is possible to improve reliability of the one-way clutch OWC. Alternatively, it is possible to reduce the one-way clutch OWC in weight.

In addition, in restraining the deterioration of durability of the one-way clutch OWC, since the rotational speed of the carrier CA increased by the first motor generator MG1 to a predetermined rotational speed higher than zero and the state of the crankshaft 13 disengaged from the one-way clutch OWC are not the reason that a load caused due to a rotational fluctuation of the carrier CA is not applied to the one-way clutch OWC, reaction force caused by the MG1 torque Tg is not input to the ring gears R of the planetary gear mechanism 38, and thus, it is possible to restrain a shock or unintended deterioration of the driving force.

In addition, in restraining the deterioration of durability of the one-way clutch OWC, starting the engine 12 is not the reason that a load caused due to a rotational fluctuation of the carrier CA is not applied to the one-way clutch OWC, the EV travelling is continuously executed.

In addition, according to the example, when the EV2 mode is prohibited and the hybrid vehicle switches to the EV1 mode, the MG1 torque Tg becomes zero. Therefore, even if the engine 12 is not caused to start, it is possible to restrain the deterioration of durability of the lock mechanism (one-way clutch OWC) against a rotational fluctuation of the third rotational element RE3 (ring gears R), and it is possible to restrain a shock or unintended deterioration of the driving force.

In addition, according to the example, the lock mechanism that fixes the carrier CA such that the carrier CA is not rotatable is the one-way clutch OWC. Therefore, the hybrid vehicle can appropriately travel in the EV2 mode in a state where the carrier CA is fixed. In addition, when a rotational fluctuation of the ring gears R is detected while the hybrid vehicle is travelling in the EV2 mode, the MG1 torque Tg becomes zero. Therefore, it is possible to restrain the deterioration of durability of the one-way clutch OWC, and it is possible to restrain a shock or unintended deterioration of the driving force.

Subsequently, another embodiment of the present disclosure will be described. In the following description, the same reference signs will be applied to a portion common to each other in Examples and the descriptions will not be repeated.

In Example 1, the one-way clutch OWC is employed as an example of the lock mechanism. In place of the one-way clutch OWC, for example, the lock mechanism may be a meshing clutch (dog clutch), a hydraulic frictional engagement device, a dry engagement device, an electromagnetic frictional engagement device (electromagnetic clutch), or a magnetic particle clutch.

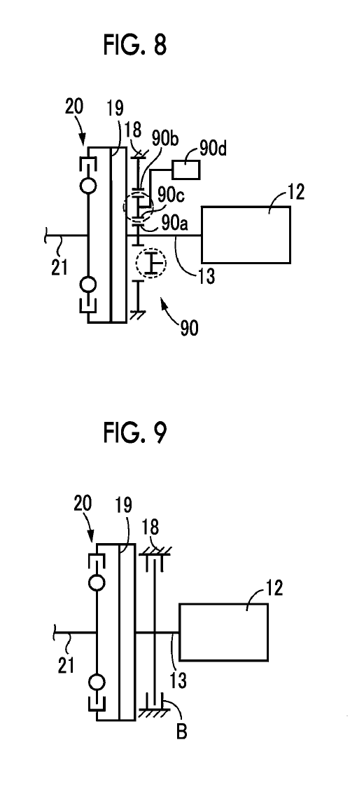

FIG. 8 is a view illustrating a meshing clutch 90. In FIG. 8, the meshing clutch 90 includes an engine side member 90a, a case side member 90b, a pinion 90c, and an actuator 90d. The engine side member 90a has a plurality of meshing teeth on its outer circumference and is provided so as to integrally rotate around the same shaft center as the crankshaft 13. The case side member 90b has a plurality of meshing teeth on its inner circumference and is fixed to the case 18. The pinion 90c has a spline on its outer circumference. The spline meshes with the meshing teeth of each of the engine side member 90a and the case side member 90b. The pinion 90c is provided so as to be movable (slidable) in a shaft center direction with respect to the engine side member 90a and the case side member 90b such that the spline meshes with the meshing teeth of each of the engine side member 90a and the case side member 90b. The actuator 90d moves the pinion 90c in the shaft center direction. The meshing clutch 90 is controlled by the actuator 90d between a state where the spline of the pinion 90c meshes with the meshing teeth of both the engine side member 90a and the case side member 90b and a state where the spline of the pinion 90c does not mesh with the meshing teeth of both the engine side member 90a and the case side member 90b. When the spline of the pinion 90c is in a state of not meshing with the meshing teeth of both the engine side member 90a and the case side member 90b (refer to the state surrounded by the dotted line of short line segments in FIG. 8), the crankshaft 13 is in a state of being rotatable relative to the case 18. Meanwhile, when the spline of the pinion 90c is in a state of meshing with the meshing teeth of both the engine side member 90a and the case side member 90b (refer to the state surrounded by the dotted line of long line segments in FIG. 8), the crankshaft 13 is in a state of not being rotatable relative to the case 18. That is, when the spline of the pinion 90c is in a state of meshing with the meshing teeth of both the engine side member 90a and the case side member 90b, the crankshaft 13 is fixed (locked) to the case 18.

FIG. 9 is a view illustrating a brake B that is a hydraulic frictional engagement device. In FIG. 9, for example, the brake B is a multi-disk hydraulic frictional engagement device of which engagement is controlled by a hydraulic actuator. The operation state of the brake B is controlled in response to the engagement pressure of oil supplied from a hydraulic control circuit (not illustrated) between an engagement state (including slip engagement state) and a released state. When the brake B is released, the crankshaft 13 is rotatable relative to the case 18. Meanwhile, when the brake B is engaged, the crankshaft 13 is in a state of not being rotatable relative to the case 18. That is, when the brake B is engaged, the crankshaft 13 is fixed (locked) to the case 18. For example, the brake B may be a clutch that causes the case 18 and the crankshaft 13 to be selectively interlocked with each other.

Hereinbefore, embodiments of the present disclosure have been described based on the drawings. The present disclosure is also applied to other aspects.

For example, in the examples, the vehicle 10 is equipped with a geartrain having an interlock relation such that the second motor generator MG2 is disposed on a shaft center different from the shaft center of the input shaft 21. However, for example, the vehicle 10 may be equipped with a geartrain having an interlock relation such that the second motor generator MG2 is disposed on the same shaft center as the shaft center of the input shaft 21.

In addition, in the examples, the planetary gear mechanism 38 may be a single planetary gear mechanism or a double planetary gear mechanism. In addition, the planetary gear mechanism 38 may be a differential gear device in which a pinion rotationally driven by the engine 12, and a pair of bevel gears meshing with the pinion are differentially interlocked with the first motor generator MG1 and the drive gear 24. In addition, the planetary gear mechanism 38 may have a configuration in which two or more planetary gear devices are interlocked with each other through a part of rotational elements configuring the planetary gear devices, and the planetary gear mechanism 38 may be a mechanism in which an engine, a motor generator, and driving wheels are interlocked with each of the rotational elements of the planetary gear devices in a power transmittable manner.

The examples are merely embodiments, and the present disclosure can be executed in aspects to which various changes and modifications are added based on the knowledge of those skilled in the art.

What is claimed is:

1. A control device for a hybrid vehicle in which the hybrid vehicle includes an engine, a first motor generator, a differential mechanism, a second motor generator, and a lock mechanism; the differential mechanism includes a first rotational element, a second rotational element, and a third rotational element; the engine is interlocked with the first rotational element in a power transmittable manner; the first motor generator is interlocked with the second rotational element in a power transmittable manner; the third rotational element is interlocked with driving wheels of the hybrid vehicle; the second motor generator is interlocked with the driving wheels in a power transmittable manner; and the lock mechanism is configured to fix the first rotational element such that the first rotational element is selectively not rotatable, the control device comprising:
a rotation detector configured to detect a rotational state of the third rotational element; and
an electronic control unit configured to:
control the lock mechanism, the first motor generator, and the second motor generator such that the hybrid vehicle travels in a dual drive motor travelling mode, the dual drive motor travelling mode being a mode in which the hybrid vehicle travels while both the first motor generator and the second motor generator serve as driving force sources for travelling in a state where the first rotational element is fixed by the lock mechanism; and
control the first motor generator such that output torque of the first motor generator becomes zero when the electronic control unit determines, based on the rotational state of the third rotational element, that the third rotational element has a rotational fluctuation while the hybrid vehicle is travelling in the dual drive motor travelling mode.

2. The control device according to claim 1, wherein the electronic control unit is configured to cause the hybrid vehicle to switch from the dual drive motor travelling mode to a single drive motor travelling mode in which solely the second motor generator serves as the driving force source for travelling such that the output torque of the first motor generator becomes zero.

3. The control device according to claim 1, wherein the lock mechanism is a one-way clutch allowing the first rotational element to rotate in a positive rotational direction that is a rotation direction at a time when the engine runs and inhibiting the first rotational element from rotating in a negative rotational direction.

4. The control device according to claim 1, wherein the electronic control unit is configured to determine that the third rotational element has a rotational fluctuation when the third rotational element is in a rotational state corresponding to a wavy road travelling state of the hybrid vehicle.

5. The control device according to claim 4,
wherein the electronic control unit is configured to calculate an integral value per predetermined time of an absolute value of a band-pass processing value for a rotational speed of the third rotational element, as a band-pass total sum, and
wherein the electronic control unit is configured to determine that the third rotational element has a rotational fluctuation when the band-pass total sum is equal to or greater than a wavy road determination threshold value.
